(19) United States
(12) Patent Application Publication
(10) Pub. No.: US 2008/0299398 A1
(43) Pub. Date: Dec. 4, 2008

(54) LIGHT EMITTING DEVICE AND METHOD FOR MANUFACTURING THE SAME

(75) Inventors: Toshio Hata, Mihara-shi (JP); Masahiro Konishi, Ikoma-shi (JP); Makoto Agatani, Mihara-shi (JP)

Correspondence Address: MORRISON & FOERSTER LLP, 1650 TYSONS BOULEVARD, SUITE 400, MCLEAN, VA, 22102, US

(73) Assignee: Sharp Kabushiki Kaisha, Osaka-shi (JP)

(21) Appl. No.: 12/130,372

(22) Filed: May 30, 2008

(30) Foreign Application Priority Data
May 30, 2007 (JP) 2007-143752

(51) Int. Cl. H01J 1/63; B32B 27/30; B32B 27/32; B32B 27/34; B32B 27/38

(52) U.S. Cl. 428/412; 428/690; 427/66; 428/413; 428/522; 428/473.5; 428/447; 428/500; 428/475.5

(57) ABSTRACT

In a light emitting device having a light emitting element, mounted on a substrate, at least one portion of which is coated with a mold component, the mold component is provided with resin particles and or inorganic material particles, phosphor particles and a sealing resin, and phosphor particles have a specific gravity different from that of resin particles and/or the inorganic material particles, and are made from a grain-shaped phosphor which, when irradiating with excited light, emits fluorescent light having a wavelength longer than that of the excited light, with resin particles and/or the inorganic material particles and the phosphor particles being dispersed in sealing resin; thus, the present invention relates to such a light emitting device and a method for manufacturing the same.

This nonprovisional application is based on Japanese Patent Application No. 2007-143752 filed on May 30, 2007 with the Japan Patent Office, the entire contents of which are hereby incorporated by reference.

### BACKGROUND OF THE INVENTION

1. Field of the Invention

This invention relates to a light emitting device which converts at least one portion of a wavelength of light emission emitted from a light emitting element by using a phosphor, and emits the resulting light, and a method for manufacturing such a light emitting device.

2. Description of the Background Art

A light emitting device, which wavelength-converts light emitted from a semiconductor light emitting element such as a light emitting diode by using a phosphor, has a small size and power consumption that is smaller than that of a candescent light bulb, and is capable of emitting light rays suitable for respective purposes of use. Therefore, this light emitting device can be utilized for backlight light sources for liquid crystal displays, cellular phones or cellular phone information terminals, for display apparatuses for use in indoor and outdoor advertisements, for indicators and illumination switches for various portable apparatuses, as well as for light sources for OA (Office Automation) apparatuses, and various research efforts have been made so as to ensure higher efficiency and higher reliability thereof.

In an attempt to emit desired white light by using such a light emitting device, the phosphor is preferably dispersed evenly in a sealing resin that secures the phosphor.

Japanese Patent Laying-Open No. 10-233533 (Patent Document 1) and Japanese Patent Laying-Open No. 2006-237649 (Patent Document 2) have disclosed methods for dispersing the phosphor evenly in a light emitting device.

FIG. 28 is a schematic cross-sectional view that shows a structure of a light emitting device formed by using a conventional manufacturing method for a light emitting device. First, referring to FIG. 28, the following description will discuss a manufacturing method for a light emitting device disclosed in Patent Document 1.

A light emitting device, shown in FIG. 28, is provided with a lead frame 100, a light emitting element 200 mounted on lead frame 100, bonding wires 300 that electrically connect lead frame 100 and light emitting element 200, a light transmitting resin 600 that contains a phosphor used for converting the wavelength of light emitted from light emitting element 200, and seals light emitting element 200, and a mold component 500 that seals these, and protects light emitting element 200.

Patent Document 1 relates to a method for forming a light emitting device, which includes a step of maintaining light transmitting resin 600, while stirring it so that the density of phosphor contained therein is made virtually constant, and a step of applying a predetermined amount of a mixture of the phosphor and light-transmitting resin 600 onto light emitting element 200, while the density of the mixture of the phosphor and light-transmitting resin 600 is maintained.

In the forming method disclosed by Patent Document 1, however, a device for stirring light-transmitting resin 600 containing the phosphor, a device for maintaining light-transmitting resin 600 at a constant temperature and a device for discharging the mixture, with the density of the phosphor in light-transmitting resin 600 being evenly maintained, are required, with the result that a complex manufacturing method is required. Moreover, it is difficult to seal light emitting element 200 with light-transmitting resin 600, while the density of the phosphor in light-transmitting resin is 600 being evenly maintained.

Moreover, FIG. 29 is a schematic cross-sectional view that shows a structure of a light emitting device formed by using another conventional method for manufacturing a light emitting device. Referring FIG. 29, the following description will discuss a method for manufacturing a light emitting device disclosed in Patent Document 2.

A light emitting device, shown in FIG. 29, is provided with a lead frame 100, a light emitting element 200 mounted on lead frame 100, bonding wires 300 that electrically connect lead frame 100 and light emitting element 200, and a mold component 500 that seals these members, with a phosphor 400 being contained therein, and protects light emitting element 200.

Patent Document 2 relates to a method for manufacturing a light emitting device, which includes a first step of preliminarily forming mixed particles in which a resin to form a material for a mold component 500, a phosphor of an inorganic material that has a specific gravity different from the resin, and emits yellow fluorescent light when irradiated with blue-color light, a second step of inserting a lead frame 100 on which a light emitting element 200 is mounted and connected thereto by a tie bar, while the particles are softened and injected into a metal mold so as to coat at least one portion of light emitting element 200, a third step of forming the resin into a solid state, and a fourth step of cutting the tie bar of lead frame 100 on which mold component 500 has been formed.

In the forming method disclosed by Patent Document 2, however, in the second step in which the above-mentioned particles are softened and injected into a metal mold so as to coat at least one portion of light emitting element 200, the phosphor precipitates in the resin to cause a problem of an uneven distribution of phosphor 400 in mold component 500. This problem occurs because the specific gravity of the phosphor is about 4 to 5, while the specific gravity of the resin is about 1 to 1.5, with the result that a separation occurs between the resin and the phosphor before the third step in which the resin is formed into a solid state. Consequently, unevenness of phosphor 400 in mold component 500 and shifts in content of phosphor 400 for respective production lots tend to occur.

### SUMMARY OF THE INVENTION

Since the phosphor itself is weak in mutual adhesive strength, it needs to be contained in a mold component that is made from a resin or the like, and seals a light emitting element, in order to place the phosphor on the light emitting element to be secured thereon. In the above-mentioned conventional technique, however, precipitation of the phosphor due to a difference in specific gravities between the resin and the phosphor is not suppressed during the manufacturing process of the mold component, resulting in the problem that the phosphor is not dispersed in the resin evenly.

Here, the inventors, etc. of the present invention have found that the content and distribution of the phosphor dispersed in the mold component give influences to factors, such as the quantity of excited light emitted from a light emitting element, the quantity of fluorescent light that is discharged by the phosphor that has absorbed the excited light and the chromaticity or the lightness, and greatly affect color irregularities and light emission irregularities in the light emitting device.

The present invention has been revised to solve the above-mentioned problems, and its objective is to provide a light emitting device that is further superior in precision to the conventional device, makes the content and distribution of the phosphor uniformly maintained in the mold component, has superior light emitting characteristics with little shifts in chromaticity, and a high yield, as well as a method for manufacturing such a light emitting device.

The present invention relates to a light emitting device that is provided with a light emitting element mounted on a substrate, at least one portion of which is coated with a mold component, and in this structure, the mold component has resin particles and/or inorganic material particles, phosphor particles and a sealing resin, and the phosphor particles have a specific gravity different from that of the resin particles, and are made from a particle-shaped phosphor which, when irradiating with excited light, emits fluorescent light having a wavelength longer than that of the excited light, and the resin particles and the phosphor particles are dispersed in the sealing resin.

Moreover, in the light emitting device of the present invention, either the device in which the mold component is provided with resin particles, phosphor particles and a sealing resin, or the device in which the mold component is provided with inorganic material particles, phosphor particles and a sealing resin may be preferably used.

Here, in the light emitting device of the present invention, the particle size of the phosphor particles is preferably made larger than the particle size of the resin particles or the inorganic material particles.

In the light emitting device of the present invention, the resin particles are preferably made from the same material as that of the sealing resin. By using the same material for the material of the resin particles as well as for the material of the sealing resin, the resin particles and the sealing resin are allowed to have superior wettability, and good adhesion to the sealing resin is prepared.

In the light emitting device of the present invention, the mold component is preferably formed into a laminated-layer structure in which layers of resin particles or inorganic material particles and layers of phosphor particles are alternately laminated in a thickness direction. Thus, the light emitting device in which the layers of resin particles and the layers of phosphor particles are alternately laminated makes it possible to provide light emission that is averaged in the chromaticity and luminance.

Moreover, in the light emitting device of the present invention, the mold component preferably has a two-layer structure in which a mixture layer, made from the resin particles, the phosphor particles and the sealing resin in a mixed state, and a sealing resin layer made from the sealing resin are stacked in the thickness direction, and in the case where the mixture layer and the sealing resin layer are formed in the thickness direction in this order from the side near the light emitting element, the resin particles contained in the mixture layer preferably has a needle insertion degree greater than that of the sealing resin of the sealing resin layer, while in the case where the sealing resin layer and the mixture layer are formed in the thickness direction in this order from the side near the light emitting element, the sealing resin in the sealing resin layer preferably has a needle insertion degree greater than that of the resin particles contained in the mixture layer.

The periphery of the light emitting element is coated with the resin particles or the sealing resin having a greater needle insertion degree so that it becomes possible to suppress a stress from the resin particles or the sealing resin and a distortion due to the volume change thereof, and consequently to suppress degradation in reliability.

In the light emitting device of the present invention, the refractive index of the sealing resin and the refractive index of the resin particles or the inorganic material particles are preferably set to the same value. Thus, it becomes possible to uniformly take out light from the light emitting element. Therefore, it is possible to obtain a light emitting element that provides uniform light emission.

Moreover, in the light emitting device of the present invention, the linear expansion coefficient of the sealing resin and the linear expansion coefficient of the resin particles or the inorganic material particles are preferably set to the same value. Thus, it becomes possible to prevent separation between the cured sealing resin and the resin particles, and consequently to improve the adhesion.

Furthermore, in the light emitting device of the present invention, the phosphor particles are preferably made from at least one or more particle-shaped phosphors selected from the group including: yellow fluorescent light emitting materials, such as Ca(Si, Al)₁₂(O, N)₁₆:Eu serving as Eu (europium) activated α-sialone, and BOSE:Eu-based materials, such as (Ba, Sr)₂SiO₄, (Y, Gd)₃Al₅O₁₂:Ce and Tb₃Al₅O₁₂:Ce; blue fluorescent light emitting materials, such as (Ba, Mg)Al₁₀O₁₇:Eu, ZnS:Ag, AlZnS:(Ag, Cu, Ga, Cl), BaMgAl₁₀O₁₇:Eu, (Sr, Ca, Ba, Mg)₅(PO₄)₃Cl:Eu, Sr₅(PO₄)₃Cl:Eu, (Ba, Sr, Eu)(Mg, Mn)Al₁₀O₁₇ and BaMg₂Al₁₆O₂₅:Eu; green fluorescent light emitting materials, such as (Ba, Mg)Al₁₀O₁₇:(Eu, Mn), (Si, Al)₆(O, N)₈:Eu serving as Eu (europium) activated β-sialone, SrAl₂O₄:Eu, Ba_{1.5}Sr_{0.5}SiO₄:Eu, BaMgAl₁₀O₁₇:(Eu, Mn), Ca₃(Sc, Mg)₂Si₃O₁₂:Ce, Lu₃Al₅O₁₂:Ce, CaSc₂O₄:Ce, ZnS:(Cu, Al), (Zn, Cd)S:(Cu, Al), Y₃Al₅O₁₂:Tb, Y₃(Al, Ga)₅O₁₂:Tb, Y₂SiO₅:Tb, Zn₂SiO₄:Mn, (Zn, Cd)S:Cu, Gd₂O₂S:Tb, (Zn, Cd)S:Ag, Y₂O₂S:Tb, (Zn, Mn)₂SiO₄, BaAl₁₂O₁₉:Mn, (Ba, Sr, Mg)O.aAl₂O₃:Mn, LaPO₄:(Ce, Tb), Zn₂SiO₄:Mn, CeMgAl₁₁O₁₉:Tb and BaMgAl₁₀O₁₇:(Eu, Mn); and red fluorescent light emitting materials, such as cousin (CaAlSiN₃:Eu) serving as an Eu (europium) activated pure nitride, (Sr, Ca)AlSiN₃:Eu, Y₂O₂S:Eu, Y₂O₃:Eu, Zn₃(PO₄)₂:Mn, (Y, Gd, Eu)BO₃, (Y, Gd, Eu)₂O₃, YVO₄:Eu, and La₂O₂S:(Eu, Sm). In the light emitting device of the present invention, by using the above-mentioned phosphor, it becomes possible to suppress hiding of light by the phosphor and consequently to improve the output of the light emitting device. Moreover, the phosphor particles of the present invention, prepared by forming phosphor into particles, are superior in the light absorption rate and conversion efficiency, and also have a wide width of excited wavelength. Therefore, it becomes possible to desirably convert even light rays in the vicinity of main wavelengths of the light emitting elements so as to emit light rays, and also to improve the mass productivity of the light emitting device.

Moreover, in the light emitting device of the present invention, the resin particles are made from at least one material selected from the group including epoxy resin, acrylic resin, imide resin, phenolic resin, silicone resin, norbornane resin, polymethyl pentene resin, amorphous nylon resin, polyallylate, polycarbonate resin, epoxy-modified silicone resin and an organic substance modified silicone resin. These materials have a light transmitting property, and are superior in heat resistance.

In the light emitting device of the present invention, the inorganic material particles are preferably made from silica gel and/or glass. The silica gel and/or glass have a light transmitting property, and are superior in heat resistance.

Moreover, in the light emitting device of the present invention, the substrate is a ceramic substrate, and the light emitting device is further provided with: a wiring pattern that is mounted on the ceramic substrate in a manner so as to form a plurality of rows in parallel with one another, a plurality of light emitting elements that are mounted between the patterned wires on the ceramic substrate, and bonding wires that electrically connect the light emitting elements and the wiring pattern to each other, and in this structure, the light emitting elements and the bonding wires are coated with the mold component. This arrangement makes it possible to distribute the phosphor evenly over a large area, and consequently to provide a light emitting device for use in illuminating apparatuses, which is less vulnerable to chromaticity shifts and luminance irregularities in light emission.

The present invention also relates to a method for manufacturing a light emitting device wherein at least one portion of a light emitting element mounted on a substrate is coated with a mold component, and the mold component is provided with resin particles and/or inorganic material particles, phosphor particles and a sealing resin, and the phosphor particles have a specific gravity different from that of the resin particles and/or inorganic material particles, and are made from a particle-shaped phosphor which, when irradiating with excited light, emits fluorescent light having a wavelength longer than that of the excited light, and the method also includes the steps of: coating the light emitting element with a mixture including the resin particles and/or the inorganic material particles, the phosphor particles and the sealing resin; and curing the sealing resin so that the mold component is formed.

In accordance with the manufacturing method of the present invention, a light emitting device that provides light emission that is less vulnerable to color shifts and irregularities in light emission can be manufactured. Moreover, those light emitting devices that are less vulnerable to color shifts and irregularities in light emission among the light emitting devices, and have a high yield can be manufactured. Even upon mass production for a long time, irregularities in light emission between a light emitting device manufactured for the first time and a light emitting device manufactured later can be made very small.

Moreover, in the method for manufacturing a light emitting device of the present invention, prior to the coating step, it is preferable to provide the step of preparing a mixture of the resin particles and/or the inorganic material particles, the phosphor particles and the sealing resin.

Furthermore, in the method for manufacturing a light emitting device of the present invention, the coating step preferably includes a first coating step of coating the light emitting element with a mixture of the resin particles and/or the inorganic material particles, and the phosphor particles, and a second coating step of coating the mixture of the resin particles and/or the inorganic material particles and the phosphor particles with the sealing resin after the first coating step.

In the method for manufacturing a light emitting device of the present invention, the first coating step is preferably designed in such a manner that layers of the resin particles and/or the inorganic material particles and layers of the phosphor particles are stacked alternately in a thickness direction into a laminated structure so that the light emitting element is coated.

The light emitting device in which layers of the resin particles and/or the inorganic material particles and layers of the phosphor particles are stacked alternately into a laminated structure makes it possible to provide light emission that is averaged in chromaticity and luminance.

The structure of the light emitting device of the present invention makes it possible to improve the color demonstrating property of light emission, and also to manufacture a liquid crystal display and a light source for illumination that hardly have color shifts in comparison with the conventional device.

Moreover, the light emitting device of the present invention is free from light emission irregularities and color irregularities as well as light emission shifts among light emitting devices produced, and has a high yield.

By using the manufacturing method of the present invention, it becomes possible to produce light emitting devices that have phosphor particles that are stable in light emission characteristics, and can provide light emission with a white-based color with high mass productivity. Moreover, since light emission irregularities can be reduced in light emitting devices formed into a comparatively simple structure, the mass productivity and yield can be improved.

In the specification, activated elements are sometimes indicated with (A, B) (for A, B element name).

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic cross-sectional view that shows a light emitting device of the present invention.

FIG. 2 is a schematic cross-sectional view that shows another light emitting device of the present invention.

FIG. 3 is a schematic cross-sectional view that shows a process in a method for manufacturing a light emitting device of the present invention.

FIG. 4 is a schematic cross-sectional view that shows a process in the method for manufacturing a light emitting device of the present invention.

FIG. 5 is a schematic cross-sectional view that shows a process in the method for manufacturing a light emitting device of the present invention.

FIG. 6 is a schematic cross-sectional view that shows a process in the method for manufacturing a light emitting device of the present invention.

FIG. 7 is a schematic cross-sectional view that shows a process in the method for manufacturing a light emitting device of the present invention.

FIG. 8A and FIG. 8B are schematic cross-sectional views that show respective processes in another method for manufacturing a light emitting device of the present invention.

FIG. 9 is a schematic cross-sectional view that shows another light emitting device of the present invention.

FIG. 10A and FIG. 10B are schematic cross-sectional views that show respective processes in a method for manufacturing a light emitting device of the present invention.

FIG. 11 is a schematic cross-sectional view that shows still another light emitting device of the present invention.

FIG. 12A and FIG. 12B are other schematic top views that show still another light emitting device of the present invention.

FIG. 13 is a schematic cross-sectional view that shows a process in a method for manufacturing a light emitting device of the present invention.

FIG. 14 is a schematic cross-sectional view that shows a process in a method for manufacturing a light emitting device of the present invention.

FIG. 15 is a schematic cross-sectional view that shows a process in a method for manufacturing a light emitting device of the present invention.

FIG. 16 is a schematic cross-sectional view that shows a process in a method for manufacturing a light emitting device of the present invention.

FIG. 17 is a schematic cross-sectional view that shows a process in a method for manufacturing a light emitting device of the present invention.

FIG. 18 is another schematic top view that shows a light emitting device of the present invention.

FIG. 19 is still another schematic top view that shows a light emitting device of the present invention.

FIG. 20 is still another schematic top view that shows a light emitting device of the present invention.

FIG. 21 is the other schematic top view that shows a light emitting device of the present invention.

FIG. 22 is a schematic perspective view that shows a fluorescent-lighting-type LED lamp.

FIG. 23 is a schematic perspective view that shows another fluorescent-lighting-type LED lamp.

FIG. 24 is a schematic perspective view that shows a light-bulb-type LED lamp.

FIG. 25 is a graph that shows chromaticity coordinates of CIE.

FIG. 26, which shows an embodiment of a light emitting device of the present invention, is a cross-sectional view showing a light emitting device containing at least one sealing resin layer in a mold component.

FIG. 27, which shows another embodiment of a light emitting device of the present invention, is a cross-sectional view showing a light emitting device containing at least one sealing resin layer in a mold component.

FIG. 28 is a schematic cross-sectional view that shows a structure of a light emitting device formed by a conventional method for manufacturing a light emitting device.

FIG. 29 is a schematic cross-sectional view that shows a structure of a light emitting device formed by another conventional method for manufacturing a light emitting device.

### DESCRIPTION OF THE PREFERRED EMBODIMENTS

In the following drawings of the present application, the same reference numerals indicate the same portions or the corresponding portions. Moreover, the dimensional factors, such as the length, size and width, in the drawings are changed appropriately for clarification and simplification of the drawings, and they do not indicate actual dimensions.

Moreover, in the drawings of the present application, descriptions are given by using “resin particles”; however, this term is used only for convenience of description. Therefore, in the structure of a light emitting device of the present invention to be described below, portions corresponding to “resin particles” may be formed only by “resin particles” or may be formed by “a mixture of resin particles and inorganic material particles”, or may be formed only by “inorganic material particles”. However, the material for resin particles is a resin, while the material for inorganic material particles is an inorganic material, and the two materials are different from each other.

### First Embodiment

FIG. 1 is a schematic cross-sectional view showing a light emitting device of the present invention. Referring to FIG. 1, the following description will be given. A light emitting device 1000 is provided with a substrate 1, patterned wires 2 formed on substrate 1, a light emitting element 3 mounted on substrate 1, bonding wires 4 used for electrically connecting patterned wires 2 and light emitting element 3 to each other, and a mold component used for sealing these. The mold component includes phosphor particles 5, resin particles 51 and a sealing resin 52. Light emitting element 3, which has P-side electrodes and N-side electrodes (not shown) formed on its one of the faces, is electrically connected to patterned wires 2 by two bonding wires, with the corresponding face serving as an upper face.

In the description of the present invention, “particles” mean grain-shaped particles, and resin particles 51 and phosphor particles 5 are preliminarily formed into grain shapes. It should be noted that, generally known methods, such as an atomizing method and a jet-mill method, may be used as the method for producing resin particles 51.

In the present invention, the mold component is allowed to contain resin particles 51 made from a resin material, and in the mold component, resin particles 51 are injected into gaps among a plurality of phosphor particles 5 so as to maintain predetermined intervals among phosphor particles 5. Moreover, sealing resin 52 is injected into gaps between resin particles 51 and phosphor particles 5 so as to coat and secure these particles so that in the mold component, resin particles 51 and phosphor particles 5 are dispersed in sealing resin 52 to be secured thereto.

Here, the particle size of phosphor particles 5 is preferably made greater than the particle size of resin particles 51. By making the particle size of resin particles 51 smaller than the particle size of phosphor particles 5, it becomes possible to prevent phosphor particles 5 from passing through gaps among resin particles 51 to form an aggregate. Resin particles 51 are particles with a grain shape having, for example, a particle size of 0.08 to 15 μm, and phosphor particles 5 are preferably particles with a grain shape having, for example, a particle size of 1 to 50 μm. Moreover, resin particles 51 are preferably prepared not as a material to be dissolved in sealing resin 52 due to softening or the like, but as a material having a fixed shape.

Moreover, the material for a phosphor forming phosphor particles 5 is made to have a specific gravity different from the material for resin particles 51 so that in general, the phosphor has a specific gravity higher than that of the material for resin particles 51. For example, the specific gravity of the material for the phosphor (for example, (Ba, Sr)₂SiO₄) is set from 4 to 5, while the specific gravity of the material for resin particles 51 (for example, silicone) is set from about 1 to 1.6. Therefore, in general, in the case where the phosphor is sealed by resin, precipitation of the phosphor tends to occur. However, in the invention of the present embodiment, since grain-shaped resin particles 51 are injected into gaps among the phosphor particles 5, the precipitation of phosphor particles 5 can be retrained. In particular, in the case where the particle size of phosphor particles 5 is made greater than the particle size of resin particles 51, it becomes possible to prevent phosphor particles 5 from passing through the gaps among resin particles 51 to precipitate.

Those light emitting elements that emit light rays having light-emission colors in a range from ultraviolet light emission to blue-color light emission as excited light rays may be used as light emitting elements 3. Here, phosphor particles 5 are prepared by forming a phosphor which, when irradiating with excited light, emits fluorescent light having a wavelength longer than that of the excited light into particles, and are allowed to emit fluorescent light. In light emitting device 1000, phosphor particles 5, which are prepared by forming a phosphor that absorbs excited light rays having, for example, wavelengths from 355 to 485 nm to emit a red-color light ray, a phosphor that absorbs them to emit a green-color light ray, a phosphor that absorbs them to emit a blue-color light ray and a phosphor that absorbs them to emit a yellow-color light ray, into particles, are mixed appropriately.

Light emitting device 1000 is designed to adjust and mix a blue-color light ray emitted from light emitting elements 3 with fluorescent light rays emitted from phosphor particles 5 appropriately so that light emissions having desired chromaticity, luminance and the like can be achieved. Since phosphor particles 5 are generally allowed to exert a better light emission efficiency when excited by an excited light wavelength having a shorter wavelength than that of the light emission wavelength, phosphor particles 5, prepared by forming a phosphor that emits fluorescent light having a longer wavelength than the excited light wavelength from light emitting elements 3 into particles, are desirably used. Here, those of ultraviolet-ray light emission and green-color light emission may be used as light emitting elements 3. Moreover, in the light emitting device of the present invention, it is only necessary to coat at least one portion of each light emitting element 3 with the mold component.

Here, in the case where color expression is made by mixing visible light rays emitted from light emitting elements 3 and visible light rays discharged from phosphor particles 5, a difference in the respective light quantities of the visible light rays causes a big issue. In the present invention, the chromaticity can be determined only by measuring the masses of phosphor particles 5 and resin particles 51 so that a light emitting device that is schematically free from color shifts and luminance irregularities can be obtained. For example, when phosphor particles 5 made from (Ba, Sr)₂SiO₄:Eu or CaAlSiN₃:Eu and resin particles 51 made from silicone are mixed to be set at a mass ratio of 1:2.78, a light emitting device having a light-bulb color can be obtained. When phosphor particles 5 made from (Ba, Sr)₂SiO₄:Eu and resin particles 51 made from silicone are mixed to be set at a mass ratio of virtually 1:4, a light emitting device having a pseudo-white color can be obtained. When phosphor particles 5 made from CaAlSiN₃:Eu or Ca₃(Sr, Mg)₂Si₃O₁₂:Ce and resin particles 51 made from silicone are mixed to be set at a mass ratio of 1:6.78, a light emitting device having a high color-demonstrating characteristic can be obtained.

The particle size of phosphor particles 5 to be used in the present invention is preferably set in a range from 1 μm to 50 μm, more preferably, from 5 μm to 15 μm. Those phosphor particles 5 having a particle size of 1 μm or less tend to form aggregates, and since these are densely precipitated in sealing resin 52, the light transmitting efficiency of excited light and fluorescent light might be reduced in the mold component.

Moreover, phosphor particles 5, set in the above-mentioned particle size range, make it possible to provide high absorbing rate and conversion efficiency of excited light with a wide width of excited wavelengths. Since light emitting device 1000 of the present invention has phosphor particles 5 with a comparatively large particle size having superior optical characteristics, it is possible to desirably convert even light rays in the vicinity of main wavelengths of the light emitting elements to provide light emission.

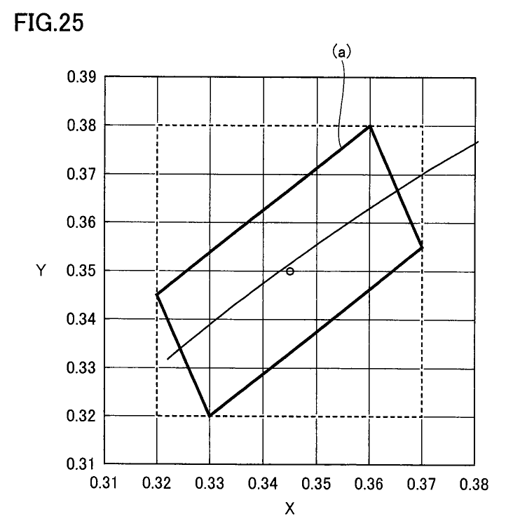

It should be noted that, the chromaticity characteristic evaluation of a light emitting device of the present invention may be conducted, for example, by using a measuring device that adopts a d·8 (diffusion illumination·8° light-receiving system) optical system in compliance with DIN5033teil7, ISOk772411, that is, condition C of JISZ8722. FIG. 25 is a graph that shows chromaticity coordinates of CIE. The light emission chromaticity of the light emitting device of the present invention is preferably adjusted so as to be located within the range (a) of the drawing.

With respect to the phosphor material to be used for forming phosphor particles 5, although not particularly limited, for example, the following inorganic phosphors may be used: yellow fluorescent light emitting materials, such as Ca(Si, Al)₁₂(O, N)₁₆:Eu serving as Eu (europium) activated α sialone, and BOSE:Eu-based materials, such as (Ba, Sr)₂SiO₄, (Y, Gd)₃Al₅O₁₂:Ce and Tb₃Al₅O₁₂:Ce; blue fluorescent light emitting materials, such as (Ba, Mg)Al₁₀O₁₇:Eu, ZnS:Ag, AlZnS:(Ag, Cu, Ga, Cl), BaMgAl₁₀O₁₇:Eu, (Sr, Ca, Ba, Mg)₅(PO₄)₃Cl:Eu, Sr₅(PO₄)₃Cl:Eu, (Ba, Sr, Eu)(Mg, Mn)Al₁₀O₁₇ and BaMg₂Al₁₆O₂₅:Eu; green fluorescent light emitting materials, such as (Ba, Mg)Al₁₀O₁₇:(Eu, Mn), (Si, Al)₆(O, N)₈:Eu serving as Eu (europium) activated βsialone, SrAl₂O₄:Eu, Ba_{1.5}Sr_{0.5}SiO₄:Eu, BaMgAl₁₀O₁₇:(Eu, Mn), Ca₃(Sc, Mg)₂Si₃O₁₂:Ce, Lu₃Al₅O₁₂:Ce, CaSc₂O₄:Ce, ZnS:(Cu, Al), (Zn, Cd)S:(Cu, Al), Y₃Al₅O₁₂:Tb, Y₃(Al, Ga)₅O₁₂:Tb, Y₂SiO₅:Tb, Zn₂SiO₄:Mn, (Zn, Cd)S:Cu, ZnS:Cu, Gd₂O₂S:Tb, (Zn, Cd)S:Ag, Y₂O₂S:Tb, (Zn, Mn)₂SiO₄, BaAl₁₂O₁₉:Mn, (Ba, Sr, Mg)O.aAl₂O₃:Mn, LaPO₄:(Ce, Tb), Zn₂SiO₄:Mn, CeMgAl₁₁O₁₉:Tb and BaMgAl₁₀O₁₇:(Eu, Mn); red fluorescent light emitting materials, such as cousin (CaAlSiN₃:Eu) serving as an Eu (europium) activated pure nitride, (Sr, Ca)AlSiN₃:Eu, Y₂O₂S:Eu, Y₂O₃:Eu, Zn₃(PO₄)₂:Mn, (Y, Gd, Eu)BO₃, (Y, Gd, Eu)₂O₃, YVO₄:Eu, and La₂O₂S:(Eu, Sm).

Among these inorganic phosphor materials, in order to obtain pseudo-white light by using a blue-color light emitting element as the light emitting element, (Ba, Sr)₂SiO₄:Eu or (Y, Gd)₃Al₅O₁₂:Ce is used as the phosphor, in order to obtain an electric bulb color, (Ba, Sr)₂SiO₄:Eu or (Y, Gd)₃Al₅O₁₂:Ce, and (Sr, Ca)AlSiN₃:Eu or CaAlSiN₃:Eu is used, and in order to obtain a high color demonstrating property, (Sr, Ca)AlSiN₃:Eu or CaAlSiN₃:Eu, and Ca₃(Sc, Mg)₂Si₃O₁₂:Ce or (Si, Al)₆(O, N)₈:Eu is preferably used. Moreover, from the viewpoints of temperature characteristics, stability and reliability, the above-mentioned phosphors are preferably used.

With respect to the phosphor material forming phosphor particles 5, rather than the organic phosphor, the inorganic phosphor is preferably used. The reason for this is because it exerts a high light emitting efficiency and is easily handled.

It should be noted that, the inorganic phosphor forming phosphor particles 5 is produced by using, for example, the following processes. First, a solution prepared by dissolving rare-earth elements of Y, Gd and Ce in an acid at stoichiometric ratios is subjected to a coprecipitation process by using oxalic acid so that a coprecipitated matter is obtained. Next, the coprecipitated matter is fired, and the resulting coprecipitated oxide and aluminum oxide are mixed to prepare a mixed material. Ammonium fluoride, serving as a flux, is mixed with the mixed material, and this is loaded into a crucible, and fired for 3 hours at a temperature of 1400° C. in the air so that a fired product is obtained. Then, the fired product is subjected to a ball milling process in water, and washed, separated, dried and lastly sieved so that a phosphor is obtained.

The material for resin particles 51 to be used in the present invention is preferably made from at least one material selected from the group including epoxy resin, acrylic resin, imide resin, phenolic resin, silicone resin, norbomane resin, polymethyl pentene resin, amorphous nylon resin, polyallylate, polycarbonate resin, epoxy-modified silicone resin and an organic substance modified silicone resin. These materials are used because they are superior in weather resistance and have a superior light-transmitting property.

The inorganic material particles to be used in the present invention are preferably made from silica gel and/or glass. These inorganic material particles are used because they are superior in weather resistance and have a superior light-transmitting property.

Moreover, the material for sealing resin 52 is preferably made from one material selected from the group including epoxy resin, acrylic resin, imide resin, phenolic resin, silicone resin, norbornane resin, polymethyl pentene resin, amorphous nylon resin, polyallylate, polycarbonate resin, epoxy-modified silicone resin and an organic substance modified silicone resin, or selected from silica gel and glass.

Here, the same material as that of resin particles 51 is preferably used as the material for sealing resin 52. In this case, since the wettability between sealing resin 52 and resin particles 51 is kept high with high adhesion being maintained, the light emitting device is made less vulnerable to defects, for example, due to bubbles and the like occurring between sealing resin 52 and resin particles 51 so that it becomes possible to improve the yield of light emitting device 1000.

In the present invention, for example, a glass epoxy substrate, a ceramic substrate or the like, may be used as substrate 1. For example, the ceramic substrate is made from one material selected from the group including aluminum oxide, aluminum nitride, boron nitride, silicon nitride, magnesium oxide, forsterite, steatite and a low-temperature sintered ceramic material, or a composite material of these.

The adhesion between light emitting elements 3 and substrate I is carried out by using a thermosetting resin or the like. Examples of the thermosetting resin include epoxy resin, acrylic resin, imide resin, phenolic resin and silicone resin.

Moreover, in the light emitting device of the present invention, the value of refractive index of sealing resin 52 is preferably set to virtually the same value as the refractive index of resin particles 51 or inorganic material particles. Here, in the present invention, the expression, “virtually the same”, refers to the fact that “the value of refractive index of sealing resin 52/the value of the refractive index of resin particles 51 or the inorganic material particles” is set within “a range from 1.38 to 1.55”. By setting the refractive index within this range, it is possible to obtain a light emitting element having uniform light emission. The refractive index can be measured by using, for example, a spectrophotometer.

In the light emitting device of the present invention, the linear expansion coefficient of the sealing resin is preferably set to virtually the same value as that of the resin particles or inorganic material particles. Here, in the present invention, the expression, “virtually the same”, refers to the face that “the linear expansion coefficient of sealing resin 52/the linear expansion coefficient of resin particles 51 or inorganic material particles” is set in “a range of 1.0E-4 to 1.0E-6 (1/k).” The linear expansion coefficient can be calculated by using a known method based upon measured values by a TMA method (Thermomechanical Analysis method).

In the present invention, light emitting element 3 may be prepared as a known LED chip, such as an LED chip made of a gallium nitride-based compound semiconductor, an LED chip made of a zinc oxide-based compound semiconductor, an LED chip made of an InGaAlP-based compound semiconductor and an LED chip made of an AlGaAs-based compound semiconductor; however, the present invention is not intended to be limited by these.

In the present invention, light emitting element 3 may have a structure in which a P-side electrode is formed on one of its surfaces, with a N-side electrode being formed on the other opposing surface, and in this case, electrodes on the upper surface side can be electrically connected to one another by using a single bonding wire.

Moreover, in place of obtaining a desired light ray by converting light emitted from light emitting element 3 by using phosphor particles 5, a light ray having a required color may be obtained by combining light emitting elements 3 that emit, for example, three colors of red, green and blue with each other.

In embodiments to be described below, with respect to phosphor particles 5, resin particles 51, inorganic material particles, sealing resin 52 and light emitting element 3, those that have described above may be used in combination.

### Second Embodiment

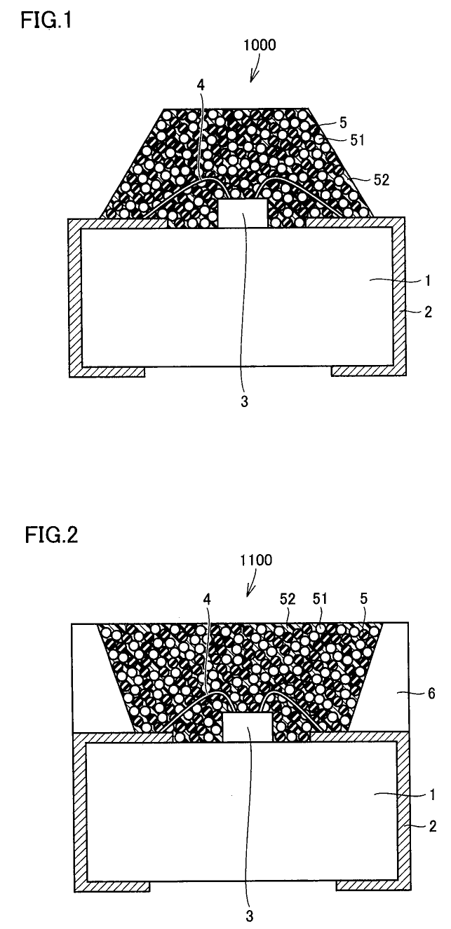

FIG. 2 is a schematic cross-sectional view showing another light emitting device of the present invention. Referring to FIG. 2, the following description will be given. A light emitting device 1100 is basically provided with a substrate 1, patterned wires 2 formed on substrate 1, a light emitting element 3, bonding wires 4 used for electrically connecting patterned wires 2 and light emitting element 3 to each other, a mold component used for sealing these and a reflector frame 6 that reflects light. The mold component includes phosphor particles 5, resin particles 51 and a sealing resin 52.

The present embodiment has the same structure as that of the first embodiment except that it is provided with a reflector frame 6. Reflector frame 6 is allowed to reflect light efficiently from a slanted face made in contact with the mold component, and thus has a function for releasing light externally from the light emitting device. Moreover, reflector frame 6 also has a function for holding the mold component. The present embodiment is provided with reflector frame 6 so that excited light and light emitted from phosphor particles 5 can be externally released efficiently.

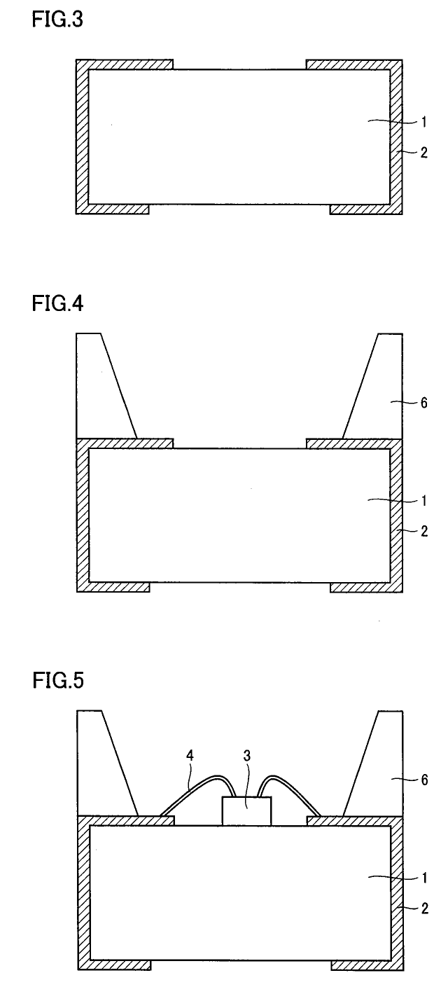

The following description will discuss a method for manufacturing a light emitting device in the present invention, for example, based upon the structure of a light emitting device of the second embodiment. FIGS. 3 to 7 are schematic cross-sectional views that respectively show processes of the method for manufacturing the light emitting device of the present invention. Referring to FIGS. 3 to 7, the following description will discuss the respective processes.

First, as shown in FIG. 3, a conductive film, such as a silver plated film, is bonded to a copper foil that forms a material for patterned wires 2 on a substrate 1. This conductive film is etched into a desired pattern by using a photoetching method or the like so that patterned wires 2 are formed.

Next, as shown in FIG. 4, reflector frame 6 is secured onto patterned wires 2 by using an adhesive sheet or the like.

Next, as shown in FIG. 5, light emitting element 3 is mounted on substrate 1 to be secured thereto by using thermosetting resin or the like. Then, light emitting element 3 and patterned wires 2 are electrically connected to each other by using bonding wires 4.

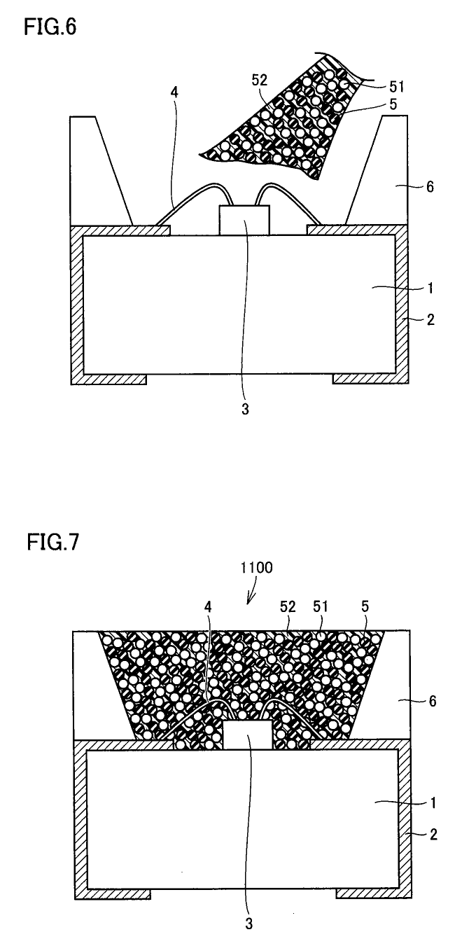

Next, as shown in FIG. 6, after mixture preparing processes in which a mixture of resin particles 51, phosphor particles 5 and sealing resin 52 is prepared, light emitting element 3 is coated with the mixture (coating process).

Lastly, as shown in FIG. 7, by curing sealing resin 52 so that a mold component made from resin particles 51, phosphor particles 5 and sealing resin 52 is formed (process for forming a mold component), light emitting device 1100 is manufactured.

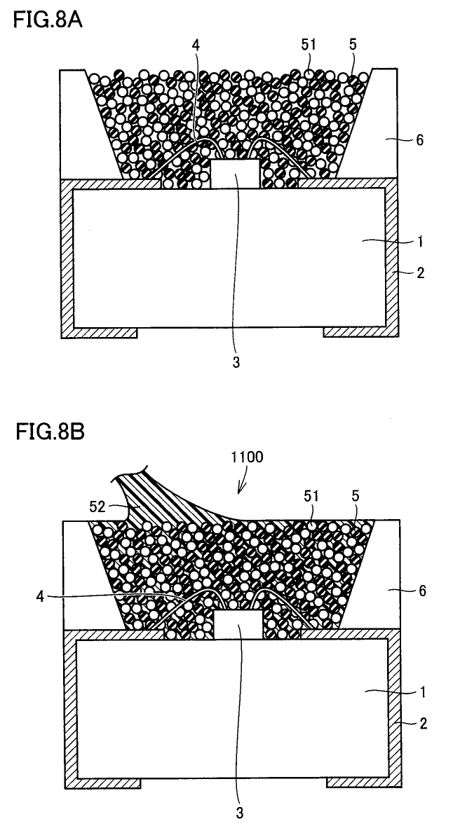

Moreover, the light emitting device of the present embodiment may be produced by using another manufacturing method. FIGS. 8A and 8B are schematic cross-sectional views that show respective processes in another method for manufacturing the light emitting device of the present invention. Referring to FIG. 8A and FIG. 8B, the following description will discuss the respective processes.

First, as shown in FIGS. 3 to 5, a structure, constituted by substrate 1, light emitting element 3 mounted on substrate 1, bonding wires 4 that electrically connect light emitting element 3 and patterned wires 2 to each other and reflector frame 6, is prepared.

As shown in FIG. 8A, light emitting element 3 is coated with a mixture of resin particles 51 and phosphor particles 5 (first coating process). At this time, phosphor particles 5 and resin particles 51 are preferably dispersed uniformly.

Next, as shown in FIG. 8B, after the first coating process, a mixture of resin particles 51 and fluorescent articles 5 is coated with sealing resin 52 (second coating process).

Lastly, by curing sealing resin 52 so that a mold component, made of resin particles 51, phosphor particles 51 and sealing resin 52, is formed (process for forming a mold component), light emitting device 1100 is manufactured.

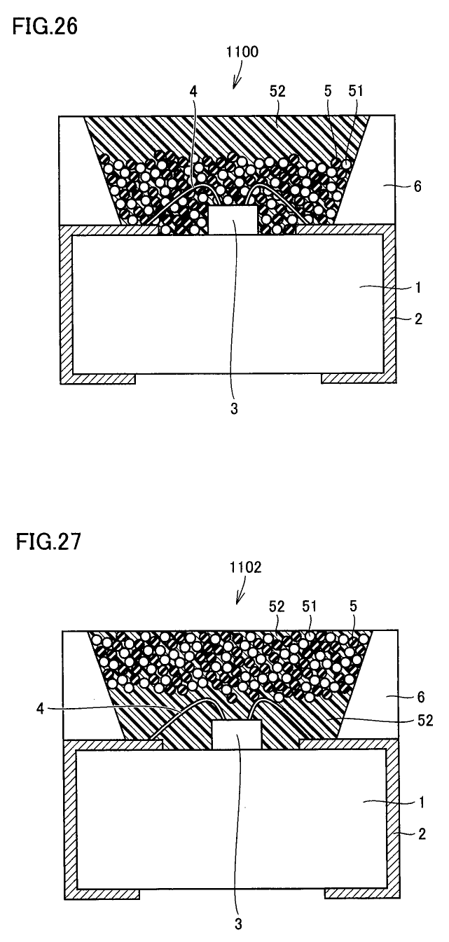

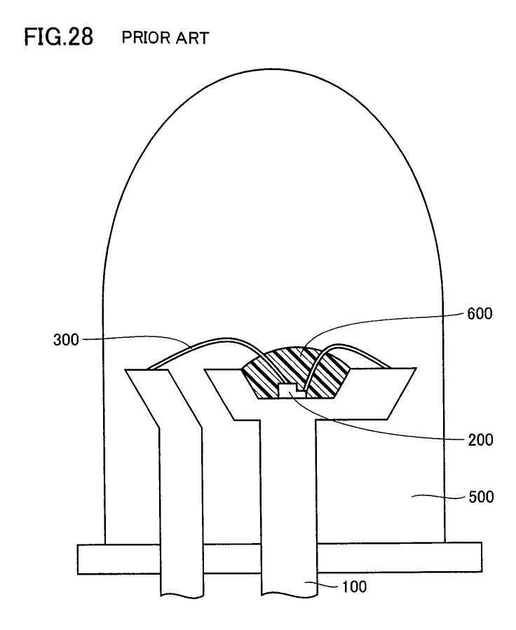

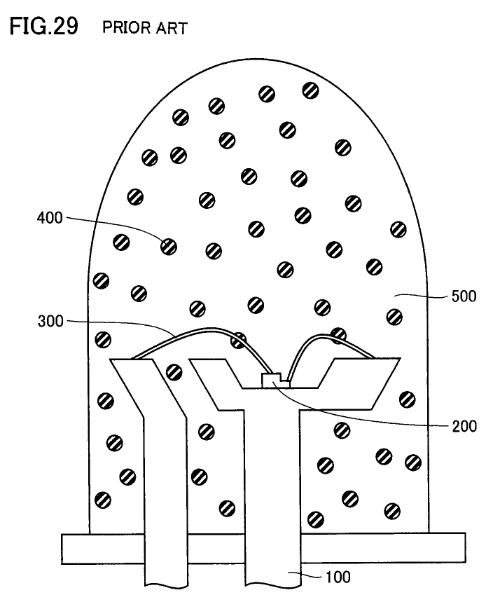

FIGS. 26 and 27, which show an embodiment of a light emitting device of the present invention, are cross-sectional views of a light emitting device in which at least one sealing resin layer is contained in a mold component.

In the embodiment shown in FIG. 26, a mixture layer in which resin particles 51, phosphor particles 5 and sealing resin 52 are mixed is formed on the side closer to light emitting element 3, a sealing resin layer made of sealing resin 52 being formed on the mixture layer in a thickness direction. That is, the mold component is formed into a two-layer laminated structure made of the mixture layer and the sealing resin layer.

In the present embodiment, with respect to the relationship between sealing resin 52 of the sealing resin layer and resin particles 51, sealing resin 52 is preferably made harder than resin particles 51 with a smaller needle insertion degree. Moreover, the relationship that the refractive index of resin particles 51 is greater than the refractive index of sealing resin 52 is preferably satisfied. By covering the periphery of light emitting element 3 with resin particles 51 that are higher than sealing resin 52 in the needle insertion degree, the stress from sealing resin 52 and the strain due to a volume change are suppressed so that it becomes possible to suppress degradation in reliability. Moreover, by using resin particles 51 that have a high refractive index, more light generated by light emitting element 3 can be taken out of light emitting element 3.

In the embodiment shown in FIG. 27, a sealing resin layer made from sealing resin 52 is formed on the side closer to light emitting element 3, and a mixture layer in which resin particles 51, phosphor particles 5 and sealing resin 52 are mixed with one another is formed on the sealing resin layer. That is, the mold component has a two-layer laminated structure composed of the sealing resin layer and the mixture layer.

In the present embodiment, with respect to the relationship between sealing resin 52 of the sealing resin layer and resin particles 51, resin particles 51 are preferably made harder than sealing resin 52 with a smaller needle insertion degree. Moreover, the relationship that the refractive index of the sealing resin layer is greater than the refractive index of resin particles 51 is preferably satisfied. By covering the periphery of light emitting element 3 with sealing resin 52 that is higher in the needle insertion degree than resin particles 51, the stress from sealing resin 52 and the strain due to a volume change are suppressed so that it becomes possible to suppress degradation in reliability. Moreover, by using sealing resin 52 that has a high refractive index, more light generated by light emitting element 3 can be taken out of light emitting element 3.

Here, the needle insertion degree is represented by 10 times the length (mm) of a specific needle that has been injected perpendicularly to a sample maintained at a predetermined temperature, and as the needle insertion degree becomes higher, the corresponding sample becomes softer. The needle insertion degree can be measured in accordance with JISK2220. Here, those resins having a needle insertion degree of about 50 (unit: 1/10 mm) are desirably used as the resin that is made in contact with the light emitting element.

### Third Embodiment

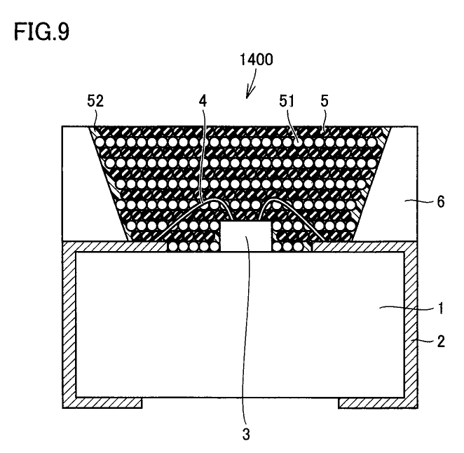

FIG. 9 is a schematic cross-sectional view showing still another light emitting device of the present invention. Referring to FIG. 9, the following description will be given. A light emitting device 1400 is basically provided with a substrate 1, patterned wires 2 formed on substrate 1, a light emitting element 3, bonding wires 4 used for electrically connecting patterned wires 2 and light emitting element 3 to each other, a mold component used for sealing these and a reflector frame 6 that reflects light. The mold component includes phosphor particles 5, resin particles 51 and a sealing resin 52.

The present embodiment has the same structure as that of the second Embodiment except that the mold component has a laminated-layer structure in which layers of resin particles 51 and layers of phosphor particles 5 are alternately laminated in a thickness direction. It should be noted that, with respect to the layers of resin particles 51 and the layers of phosphor particles 5, the thicknesses and the numbers of the respective layers are not particularly limited, as long as they are stacked in the thickness direction. In accordance with the present embodiment, light emission that is averaged in the chromaticity and luminance is provided, for example, when light emitting device 1400 is viewed from above its surface.

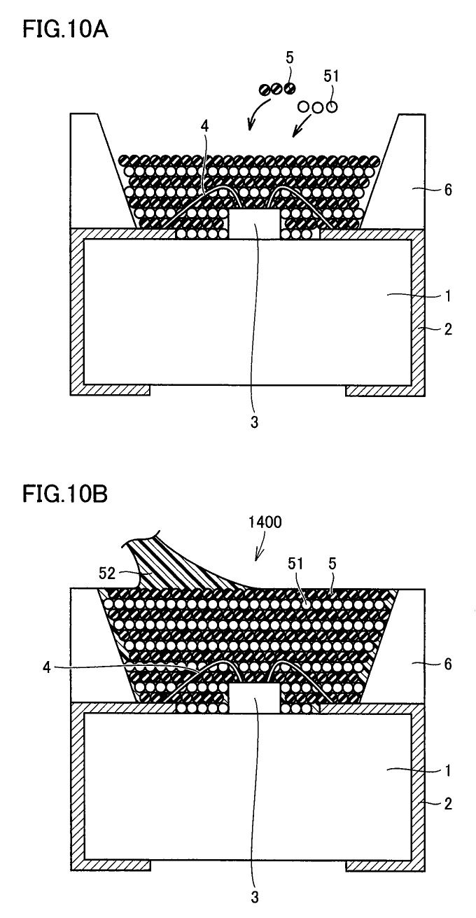

The following description will discuss a method for manufacturing a light emitting device in the present invention, for example, based upon the structure of a light emitting device of the third embodiment. FIGS. 10A and 10B are schematic cross-sectional views that respectively show processes of the method for manufacturing the light emitting device of the present invention. Referring to FIGS. 10A and 10B, the following description will discuss the respective processes.

First, similar to the manufacturing processes described referring to FIGS. 3 to 5, a structure, constituted by a substrate 1, light emitting element 3 mounted on substrate 1, bonding wires 4 that electrically connect light emitting element 3 and patterned wires 2 to each other, and reflector frame 6, is manufactured.

Next, as shown in FIG. 10A, layers of resin particles 51 and layers of phosphor particles 5 are alternately formed in the thickness direction successively into a laminated structure so that light emitting element 3 is coated with the mixture of resin particles 51 and phosphor particles 5 (First coating process).

Next, as shown in FIG. 10B, after the first coating process, the mixture of resin particles 51 and phosphor particles 5 is coated with sealing resin 52. At this time, the coating process is carried out in such a manner that sealing resin 52 is embedded into gaps between resin particles 51 and phosphor particles 5 (Second coating process).

Lastly, by curing sealing resin 52 so that a mold component made from resin particles 51, phosphor particles 5 and sealing resin 52 is formed (process for forming a mold component), light emitting device 1400 is manufactured.

As described above, by successively forming those layers alternately in the thickness direction into a laminated structure, it is possible to manufacture a light emitting device that can prevent deposition of the phosphor, with phosphor particles being evenly distributed, and is superior in the uniformity of chromaticity and luminance as well as in its reproducibility.

### Fourth Embodiment

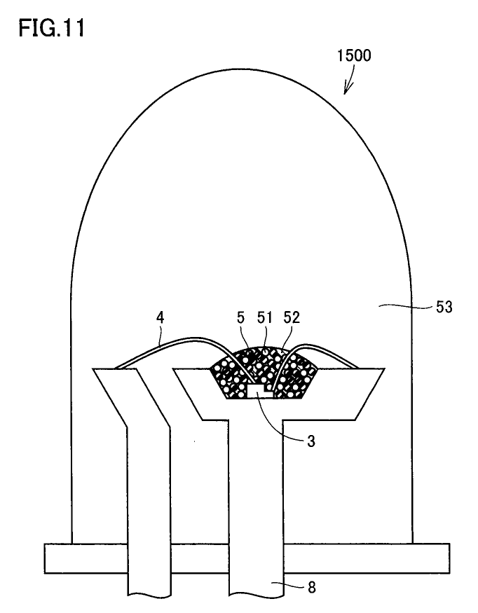

FIG. 11 is a schematic cross-sectional view showing still another light emitting device of the present invention. Referring to FIG. 11, the following description will be given. A light emitting device 1500, which is a light emitting device having a shell shape, is basically provided with a lead frame 8 that also serves as a mounting substrate, a light emitting element mounted on lead frame 8, bonding wires 4 that electrically connect lead frame 8 and light emitting element 3 to each other, a mold component that seals these, and a shell-shaped sealing resin 53 that further seals these. The mold component includes phosphor particles 5, resin particles 51 and sealing resin 52.

In the present embodiment, with respect to light emitting element 3, phosphor particles 5, resin particles 51 and sealing resin 52, those described in the first embodiment may be used appropriately.

Light emitting device 1500 of the present invention makes it possible to emit light rays having a high color demonstrating property.

### Fifth Embodiment

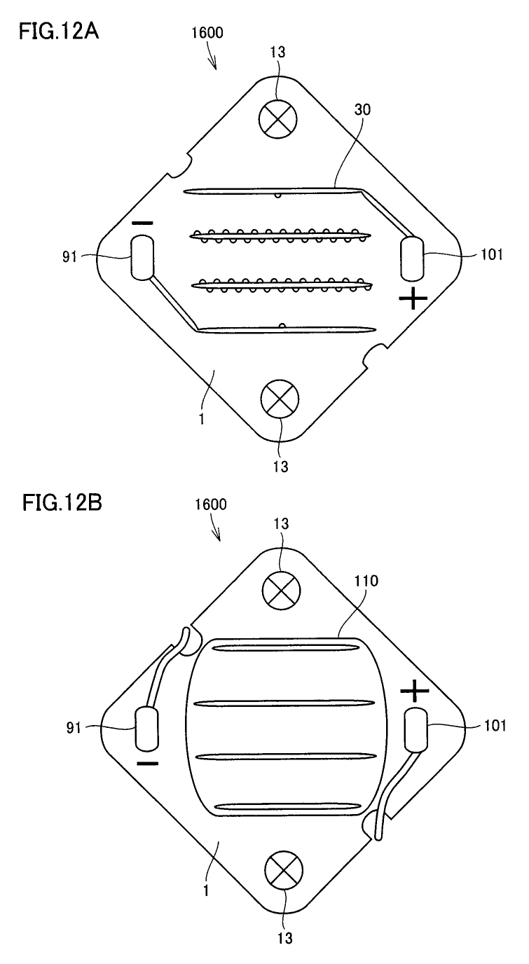

FIGS. 12A and 12B are schematic top views showing still another light emitting device of the present invention. First, referring to FIG. 12A, the following description will be given. A light emitting device 1600 has a structure in which a wiring pattern 30 is formed so that a plurality of rows in parallel with one another are mounted on a substrate 1 made from a ceramic material, or preferably, from aluminum oxide, and a plurality of light emitting elements (not shown) are mounted on portions of substrate 1 having no wiring pattern 30 formed thereon, and the light emitting elements and wiring pattern 30 are electrically connected to each other through bonding wires (not shown). Here, wiring pattern 30 is electrically connected to a negative electrode external connecting portion 91 and a positive electrode external connecting portion 101. Moreover, as shown in FIG. 12B, the light emitting elements and the bonding wires are coated with a light emitting portion 110. Light emitting portion 110 may also cover wiring pattern 30. Here, light emitting portion 110 is formed by combining the light emitting elements with the mold component. Moreover, negative electrode external connecting portion 91 and positive electrode external connecting portion 101 may be used for electrically connecting light emitting device 1600 to an external power supply or the like. Here, substrate 1 may be provided with screws 13 used for installing light emitting device 1600.

Although not particularly limited, the layout of the light emitting elements on substrate 1 of light emitting device 1600 is preferably carried out so that they are mounted to be aligned in one row. In particular, the light emitting elements are preferably arranged linearly so as to be made in parallel with the layout of wiring pattern 30. In the layout of the light emitting elements, by adjusting the gaps of the layout positions of the respective light emitting elements, a desired light emission luminance can be set and the chromaticity adjustment and heat releasing adjustment can be carried out easily.

Moreover, the external shape of light emitting device 1600, that is, the shape of substrate 1, is preferably formed into a virtually square shape, and the shape of light emitting portion 110 is preferably formed into a virtually rectangular shape. By forming substrate 1 and light emitting portion 110 into the above-mentioned shapes, negative electrode external connecting portion 91, positive electrode external connecting portion 101, holes used for screws 13 as well as for external connecting, and the like can be formed in a properly arranged manner.

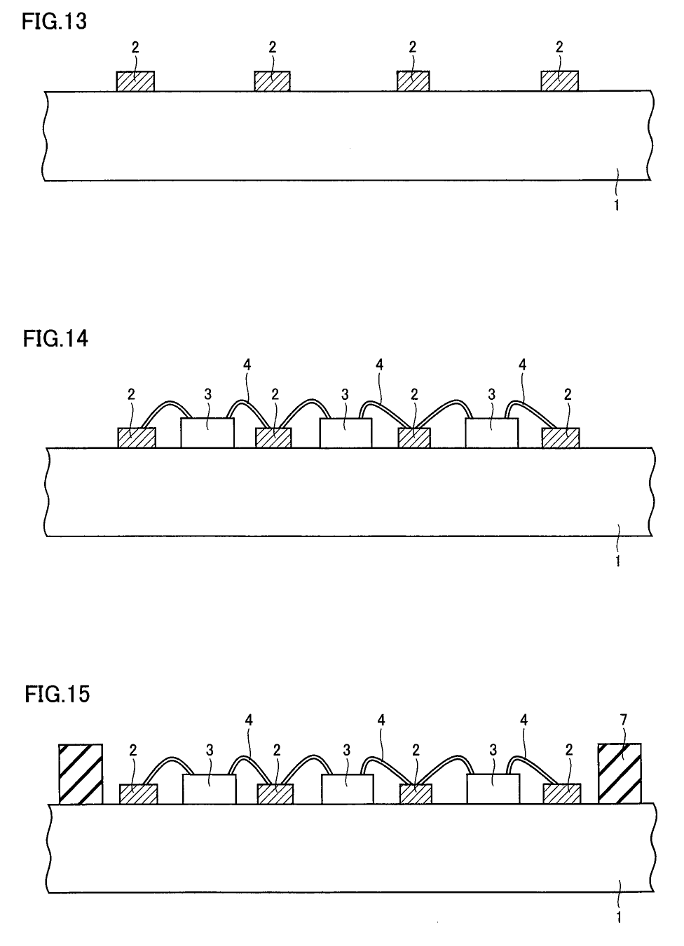

The following description will discuss a method for manufacturing a light emitting device in the present invention, for example, based upon the structure of a light emitting device of the fifth embodiment. FIGS. 13 to 17 are schematic cross-sectional views that respectively show processes of the method for manufacturing the light emitting device of the present invention. Referring to FIGS. 13 to 17, the following description will discuss the respective processes.

First, as shown in FIG. 13, a conductive film such as a silver plated film is printed onto a copper foil that forms a material for patterned wires 2 on substrate 1. This conductive film is etched into a desired pattern by using a photoetching method or the like so that patterned wires 2 are formed.

Next, as shown in FIG. 14, light emitting elements 3 are mounted on substrate I to be secured thereto by using thermosetting resin or the like. Then, light emitting elements 3 and patterned wires 2 are mutually connected electrically by using bonding wires 4.

Next, as shown in FIG. 15, a silicone resin rubber sheet 7 having a rectangular shape is mounted on substrate 1 in a manner so as to surround light emitting elements 3, wiring patterns 2 and bonding wires 4, and made in tightly contact therewith.

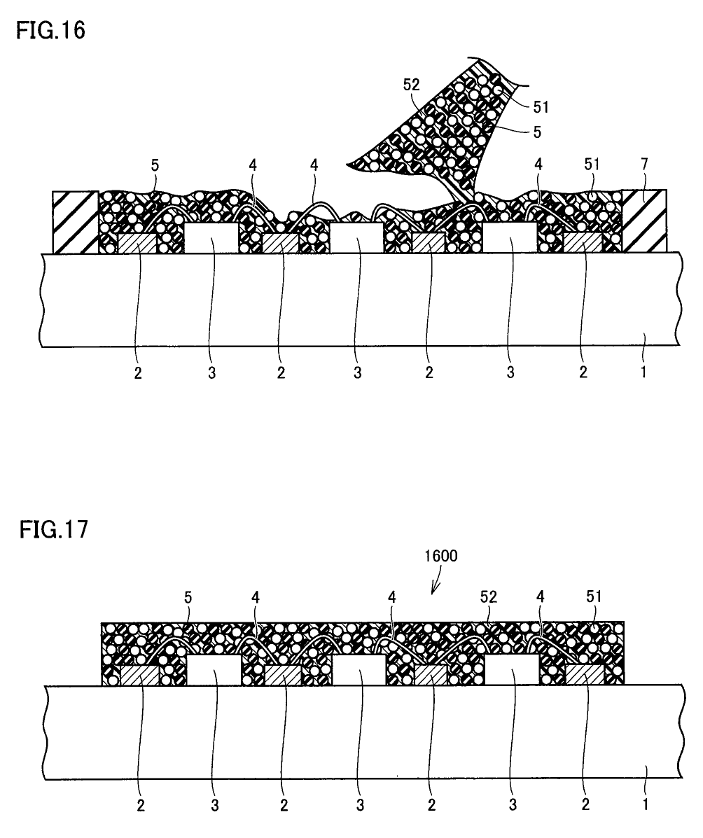

Next, as shown in FIG. 16, after processes for preparing a mixture of resin particles 51, phosphor particles 5 and sealing resin 52, light emitting elements 3 are coated with the mixture (coating process).

Lastly, as shown in FIG. 17, after curing sealing resin 52, silicone resin rubber sheet 7 is then removed so that a mold component made from resin particles 51, phosphor particles 5 and sealing resin 52 is formed (process for forming a mold component); thus, light emitting device 1600 is manufactured.

In this structure, silicone resin rubber sheet 7 has a function like a dam that prevents the mixture of resin particles 51, phosphor particles 5 and sealing resin 52 from leaking out. Consequently, silicone resin rubber sheet 7 has such a function that it can be referred to as a dam sheet. Here, silicone resin rubber sheet 7 may be used many times. Moreover, by changing the layout of the dam sheet, the shape of light emitting portion 110 can be easily changed in various ways.

### Sixth Embodiment

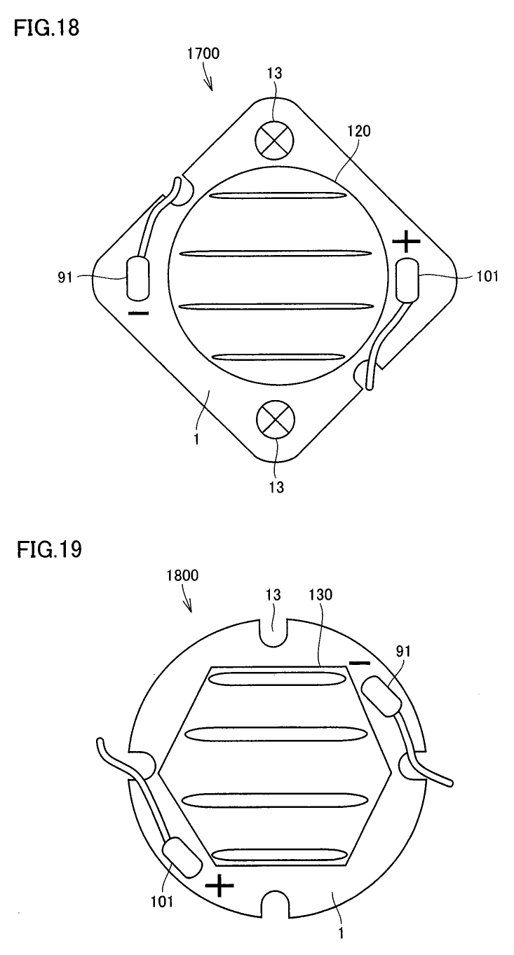

FIG. 18 is a schematic top view that shows still another light emitting device of the present invention. Referring to FIG. 18, the following description will be given. The present embodiment has a modified structure of the fifth embodiment. Therefore, a light emitting device 1700 in the example shown in FIG. 18 has a similar structure to that of light emitting device 1600 in the example shown in FIGS. 12A and 12B except for some portions, and those portions having similar structures are indicated by the same reference numerals, and the description thereof is not given.

The present embodiment differs from the fifth embodiment in that the external shape of light emitting device 1700, that is, substrate 1, is formed into a virtually square shape and in that the shape of a light emitting portion 120 is formed into a virtually round shape. In accordance with the present embodiment, light emitting portion 120 having the round shape is kept symmetrical relative to any directions so that the directional angle of light emission is made uniform.

### Seventh Embodiment

FIG. 19 is a schematic top view that shows still another light emitting device of the present invention. Referring to FIG. 19, the following description will be given. The present embodiment has a modified structure of the fifth embodiment. Therefore, a light emitting device 1800 in the example shown in FIG. 19 has a similar structure to that of light emitting device 1600 in the example shown in FIGS. 12A and 12B except for some portions, and those portions having similar structures are indicated by the same reference numerals, and the description thereof is not given.

The present embodiment differs from the fifth embodiment in that the external shape of light emitting device 1800, that is, substrate 1, is formed into a virtually round shape and in that the shape of a light emitting portion 130 is formed into a virtually hexagonal shape. In accordance with the present embodiment, light emitting portion 130 having the hexagonal shape is kept symmetrical relative to any directions so that the directional angle of light emission is made uniform.

### Eighth Embodiment

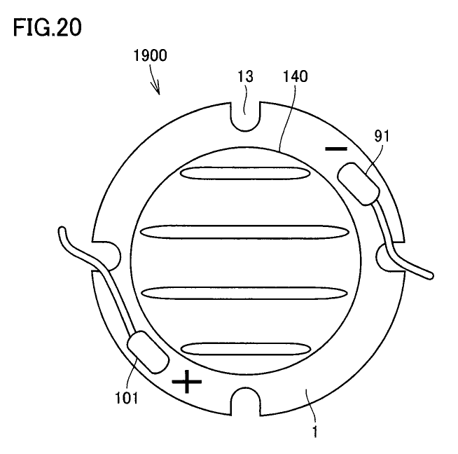

FIG. 20 is a schematic top view that shows still another light emitting device of the present invention. Referring to FIG. 20, the following description will be given. The present embodiment has a modified structure of the fifth embodiment. Therefore, a light emitting device 1900 in the example shown in FIG. 20 has a similar structure to that of light emitting device 1600 in the example shown in FIGS. 12A and 12B except for some portions, and those portions having similar structures are indicated by the same reference numerals, and the description thereof is not given.

The present embodiment differs from the fifth embodiment in that the external shape of light emitting device 1900, that is, substrate 1, is formed into a virtually round shape and in that the shape of a light emitting portion 140 is formed into a virtually round shape. In accordance with the present embodiment, light emitting portion 140 having the round shape is kept symmetrical relative to any directions so that the directional angle of light emission is made uniform.

### Ninth Embodiment

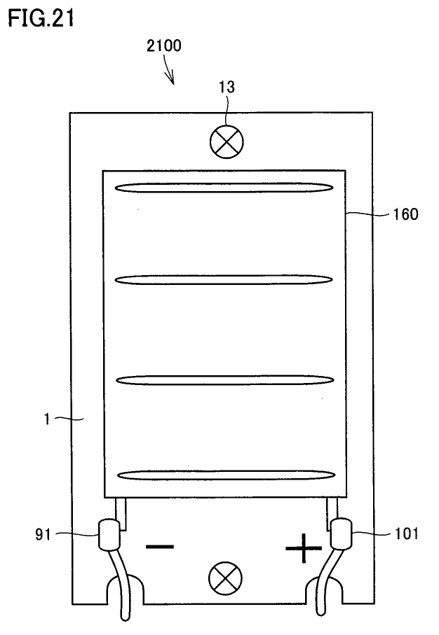

FIG. 21 is a schematic top view that shows still another light emitting device of the present invention. Referring to FIG. 21, the following description will be given. The present embodiment has a modified structure of the fifth embodiment. Therefore, a light emitting device 2100 in the example shown in FIG. 21 has a similar structure to that of light emitting device 1600 in the example shown in FIGS. 12A and 12B except for some portions, and those portions having similar structures are indicated by the same reference numerals, and the description thereof is not given.

The present embodiment differs from the fifth embodiment in that the external shape of light emitting device 2100, that is, substrate 1, is formed into a virtually rectangular shape and in that the shape of a light emitting portion 160 is formed into a virtually rectangular shape. Since the rectangular shapes are prepared, the device can be easily placed in a gap portion.

### <Application of Light Emitting Device as a Light Source for Illumination>

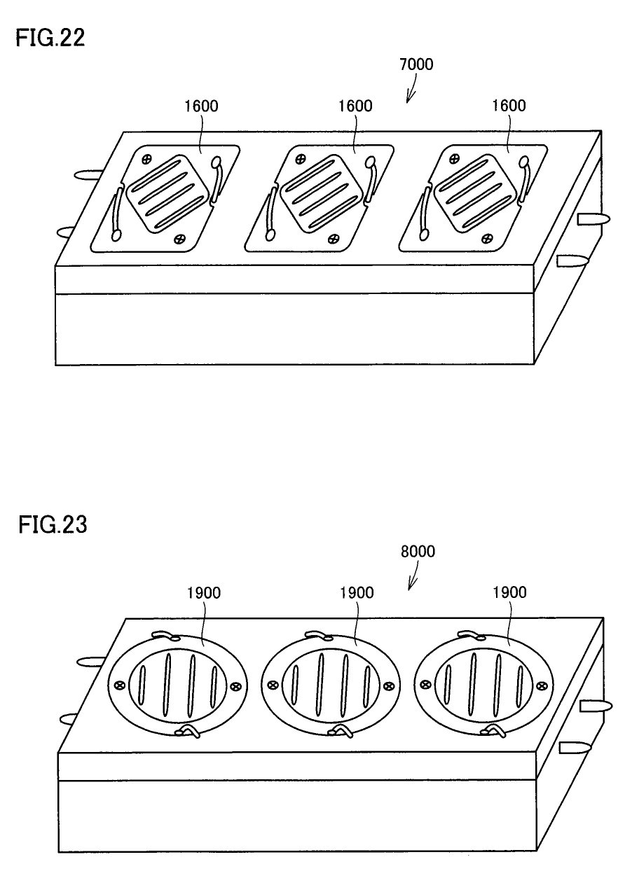

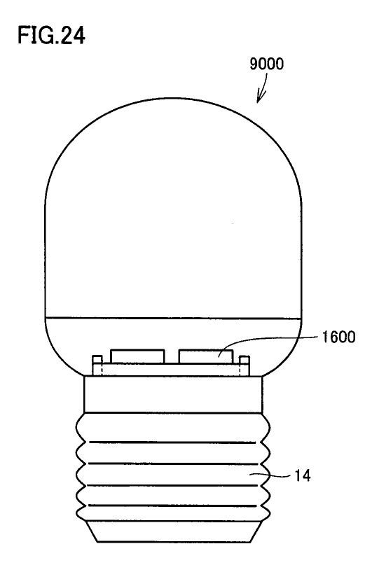

FIGS. 22 and 23 are schematic perspective views showing a fluorescent-lighting-type LED lamp. FIG. 24 is a schematic cross-sectional view showing a light-bulb-type LED lamp.

As shown in FIG. 22, by combining a plurality of light emitting devices 1600 described in the fifth embodiment, a fluorescent-lighting-type LED lamp 7000 can be manufactured. Moreover, as shown in FIG. 23, by combining a plurality of light emitting devices 1900 described in the eighth embodiment, a light-bulb-type LED lamp 8000 can be manufactured. Moreover, as shown in FIG. 24, by combining a plurality of light emitting devices 1600 described in the fifth embodiment, a light-bulb-type LED lamp 9000 with a socket portion 14 can be manufactured.

It should be noted that, in addition to the light emitting devices of the fifth embodiment and the eighth embodiment, by combining the above-mentioned modes, materials and the like of the light emitting device and light emitting portions appropriately, the above-mentioned LED lamp can be manufactured.

Although the present invention has been described and illustrated in detail, it is clearly understood that the same is by way of illustration and example only and is not to be taken by way of limitation, the scope of the present invention being interpreted by the terms of the appended claims.

What is claimed is:

1. A light emitting device comprising:
a light emitting element, mounted on a substrate, at least one portion of which is coated with a mold component, wherein
said mold component includes resin particles and/or inorganic material particles, phosphor particles and a sealing resin;
said phosphor particles have a specific gravity different from that of said resin particles, and are made from a particle-shaped phosphor which, when irradiating with excited light, emits fluorescent light having a wavelength longer than that of said excited light; and
said resin particles and said phosphor particles are dispersed in said sealing resin.

2. The light emitting device according to claim 1, wherein said mold component comprises resin particles, phosphor particles and a sealing resin.

3. The light emitting device according to claim 2, wherein said resin particles are made from the same material as that of said sealing resin.

4. The light emitting device according to claim 2, wherein said mold component is formed into a two-layer structure in which a mixture layer, made from said resin particles, said phosphor particles and said sealing resin in a mixed state, and a sealing resin layer made from the sealing resin are stacked in a thickness direction;
in the case where the mixture layer and the sealing resin layer are formed in the thickness direction in this order from the side near said light emitting element, the resin particles contained in said mixture layer has a needle insertion degree greater than that of the sealing resin of the sealing resin layer;
while in the case where the sealing resin layer and the mixture layer are formed in the thickness direction in this order from the side near said light emitting element, the sealing resin in said sealing resin layer has a needle insertion degree greater than that of the resin particles contained in said mixture layer.

5. The light emitting device according to claim 2, wherein said resin particles are made from at least one material selected from the group including epoxy resin, acrylic resin, imide resin, phenolic resin, silicone resin, norbornane resin, polymethyl pentene resin, amorphous nylon resin, polyallylate, polycarbonate resin, epoxy-modified silicone resin and an organic substance modified silicone resin.

6. The light emitting device according to claim 1, wherein said mold component comprises inorganic material particles, phosphor particles and a sealing resin.

7. The light emitting device according to claim 6, wherein said inorganic material particles are made from silica gel and/or glass.

8. The light emitting device according to claim 1, wherein said phosphor particles have a particle size that is larger than the particle size of said resin particles or said inorganic material particles.

9. The light emitting device according to claim 1, wherein said mold component is formed into a laminated-layer structure in which layers of said resin particles or said inorganic material particles and layers of said phosphor particles are stacked alternately in a thickness direction.

10. The light emitting device according to claim 1, wherein said sealing resin has a value of refractive index that is virtually the same as the value of refractive index of said resin particles or said inorganic material particles.

11. The light emitting device according to claim 1, wherein said sealing resin has a linear expansion coefficient that is virtually the same as the linear expansion coefficient of said resin particles or said inorganic material particles.

12. The light emitting device according to claim 1, wherein said phosphor particles are made from at least one or more materials selected from the group including:
yellow fluorescent light emitting materials, such as
Ca(Si, Al)₁₂(O, N)₁₆:Eu serving as Eu (europium) activated α-sialone, and BOSE:Eu-based materials, such as (Ba, Sr)₂SiO₄,
(Y, Gd)₃Al₅O₁₂:Ce
and Tb₃Al₅O₁₂:Ce;
blue fluorescent light emitting materials, such as (Ba, Mg)Al₁₀O₁₇:Eu, ZnS:Ag,
AlZnS:(Ag,Cu, Ga, Cl),
BaMgAl₁₀O₁₇:Eu,
(Sr, Ca, Ba, Mg)₅(PO₄)₃Cl:Eu,
Sr₅(PO₄)₃Cl:Eu,
(Ba, Sr, Eu)(Mg, Mn)Al₁₀O₁₇ and
BaMg₂Al₁₆O₂₅:Eu;
green fluorescent light emitting materials, such as (Ba, Mg)Al₁₀O₁₇:(Eu, Mn),
(Si, Al)₆(O, N)₈:Eu serving as Eu (europium) activated β-sialone,
SrAl₂O₄:Eu,
Ba_{1.5}Sr_{0.5}SiO₄:Eu,
BaMgAl₁₀O₁₇:(Eu, Mn),
Ca₃(Sc, Mg)₂Si₃O₁₂:Ce,
Lu₃Al₅O₁₂:Ce,
CaSc₂O₄:Ce,
ZnS:(Cu, Al),
(Zn, Cd)S:(Cu, Al),
Y₃Al₅O₁₂:Tb,
Y₃(Al, Ga)₅O₁₂:Tb,
Y₂SiO₅:Tb,
Zn₂SiO₄:Mn,
(Zn, Cd)S :Cu,
ZnS:Cu,
Gd₂O₂S:Tb,
(Zn, Cd)S:Ag,
Y₂O₂S:Tb,
(Zn, Mn)₂SiO₄,
BaAl₁₂O₁₉:Mn,
(Ba, Sr, Mg)O.aAl₂O₃:Mn,
LaPO₄:(Ce, Tb),
Zn₂SiO₄:Mn,
CeMgAl₁₁O₁₉:Tb and
BaMgAl₁₀O₁₇:(Eu, Mn); and
red fluorescent light emitting materials, such as cousin (CaAlSiN₃:Eu) serving as an Eu (europium) activated pure nitride,
(Sr, Ca)AlSiN₃:Eu,
Y₂O₂S Eu,
Y₂O₃:Eu,
Zn₃(PO₄)₂:Mn,
(Y, Gd, Eu)BO₃,
(Y, Gd, Eu)₂O₃,
YVO₄:Eu, and
La₂O₂S:(Eu, Sm).

13. The light emitting device according to claim 1, wherein said substrate is a ceramic substrate, and the light emitting device further comprises:
a wiring pattern that is mounted on said ceramic substrate in a manner so as to form a plurality of rows in parallel with one another,
a plurality of said light emitting elements that are mounted between said patterned wires on said ceramic substrate, and
bonding wires that electrically connect said light emitting elements and said wiring pattern to each other, wherein
said light emitting elements and said bonding wires are coated with said mold component.

14. A method for manufacturing a light emitting device wherein at least one portion of a light emitting element mounted on a substrate is coated with a mold component,
said mold component comprises resin particles and/or inorganic material particles, phosphor particles and a sealing resin,
said phosphor particles have a specific gravity different from that of said resin particles and/or said inorganic material, and are made from a particle-shaped phosphor which, when irradiating with excited light, emits fluorescent light having a wavelength longer than that of said excited light, comprising the steps of:
coating said light emitting element with a mixture including said resin particles and/or said inorganic material particles, said phosphor particles and said sealing resin; and
curing said sealing resin so that the mold component is formed.

15. The method for manufacturing a light emitting device according to claim 14, further comprising the step of:
preparing a mixture of said resin particles and/or said inorganic material particles, said phosphor particles and said sealing resin before said coating step.

16. The method for manufacturing a light emitting device according to claim 14, wherein said coating step includes:
a first coating step of coating said light emitting element with a mixture of said resin particles and/or said inorganic material particles, and said phosphor particles; and
a second coating step of coating the mixture of said resin particles and/or said inorganic material particles and said phosphor particles with said sealing resin after said first coating step.

17. The method for manufacturing a light emitting device according to claim 14, wherein in said first coating step, layers of said resin particles and/or said inorganic material particles and layers of said phosphor particles are stacked alternately in a thickness direction into a laminated structure so that said light emitting element is coated.
